(19) United States
(12) Patent Application Publication
(10) Pub. No.: US 2013/0204457 A1
(43) Pub. Date: Aug. 8, 2013

(54) INTERACTING WITH VEHICLE CONTROLS THROUGH GESTURE RECOGNITION

(71) Applicants: Anthony Gerald King, Ann Arbor, MI (US); Jeffrey Thomas Remillard, Ypsilanti, MI (US); Jeff Allen Greenberg, Ann Arbor, MI (US)

(72) Inventors: Anthony Gerald King, Ann Arbor, MI (US); Jeffrey Thomas Remillard, Ypsilanti, MI (US); Jeff Allen Greenberg, Ann Arbor, MI (US)

(73) Assignee: FORD GLOBAL TECHNOLOGIES, LLC, DEARBORN, MI (US)

(21) Appl. No.: 13/366,388

(22) Filed: Feb. 6, 2012

(51) Int. Cl. G06F 7/00

(52) U.S. Cl. 701/1

(57) ABSTRACT

A gesture-based recognition system obtains a vehicle occupant's desired command inputs through recognition and interpretation of his gestures. An image of the vehicle's interior section is captured and the occupant's image is separated from the background, in the captured image. The separated image is analyzed and a gesture recognition processor interprets the occupant's gesture from the image. A command actuator renders the interpreted desired command to the occupant along with a confirmation message, before actuating the command. When the occupant confirms, the command actuator actuates the interpreted command. Further, an inference engine processor assesses the occupant's state of attentiveness and conveys signals to a drive assist system if the occupant in inattentive. The drive-assist system provides warning signals to the inattentive occupant if any potential threats are identified. Further, a driver recognition module readjusts a set of vehicle's personalization functions to pre-stored settings, on recognizing the driver.

### BACKGROUND

This disclosure relates to driver and machine interfaces in vehicles, and, more particularly, to such interfaces which permit a driver to interact with the machine without physical contact.

Systems for occupant's interaction with a vehicle are now available in the art. An example is the ‘SYNC’ system that provides easy interaction of a driver with the vehicle, including options to make hands-free calls, manage musical controls and other functions through voice commands, use a ‘push-to-talk’ button on the steering wheel, and access the internet when required. Further, many vehicles are equipped with human-machine interfaces provided at appropriate locations. This includes switches on the steering wheel, knobs on the center stack, touch screen interfaces and track-pads.

At times, many of these controls are not easily reachable by the driver, especially those provided on the center stack. This may lead the driver to hunt for the desired switches and quite often, the driver is required to stretch out his hand to reach the desired controlling function(s). Steering wheel switches are easily reachable, but, due to limitation on the space available thereon, there is a constraint on operating advanced control features through steering wheel buttons. Though voice commands may be assistive in this respect, this facility can be cumbersome when used for simple operations requiring a variable input, such as, for instance, adjusting the volume of the music system, changing tracks or flipping through albums, tuning the frequency for the radio system, etc. For such tasks, voice command operations take longer at times, and the driver prefers to control the desired operation through his hands, rather than providing repetitive commands in cases where the voice recognition system may not recognize the desired command in a first utterance.

Therefore, there exists a need for a better system for enabling interaction between the driver and the vehicle's control functions, which can effectively address the aforementioned problems.

### SUMMARY OF THE INVENTION

The present disclosure describes a gesture-based recognition system, and a method for interpreting the gestures of a vehicle's occupant, and actuating corresponding desired commands after recognition.

In one embodiment, this disclosure provides a gesture-based recognition system to interpret the gestures of a vehicle occupant and obtain the occupant's desired command inputs. The system includes a means for capturing an image of the vehicle's interior section. The image can be a two-dimensional image or a three-dimensional depth map corresponding to the vehicle's interior section. A gesture recognition processor separates the occupant's image from the background in the captured image, analyzes the image, interprets the occupant's gesture from the separated image, and generates an output. A command actuator receives the output from the gesture recognition processor and generates an interpreted command. The actuator further generates a confirmation message corresponding to the interpreted command, delivers the confirmation message to the occupant and actuates the command on receipt of a confirmation from the occupant. The system further includes an inference engine processor coupled to a set of sensors. The inference engine processor evaluates the state of attentiveness of the occupant and receives signals from the sensors, corresponding to any potential threats. A drive-assist system is coupled to the inference engine processor and receives signals from it. The drive-assist system provides warning signals to the occupant when the inference engine detects any potential threat, at a specific time, based on the attentiveness of the occupant.

In another embodiment, this disclosure provides a method of interpreting a vehicle occupant's gestures and obtaining the occupant's desired command inputs. The method includes capturing an image of the vehicle's interior section and separating the occupant's image from the captured image. The separated image is analyzed, and the occupant's gesture is interpreted from the separated images. The occupant's desired command is then interpreted and a corresponding confirmation message is delivered to the occupant. On receipt of a confirmation, the interpreted command is actuated.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is a schematic of a gesture-based recognition system in accordance with the present disclosure.

FIG. 2 to FIG. 4 are the typical gestures that can be interpreted by the gesture-based recognition system of the present disclosure.

FIG. 5 is a flowchart corresponding to a method of interpreting a vehicle occupant's gestures and obtaining occupant's desired command input, in accordance with the present disclosure.

### DETAILED DESCRIPTION OF ILLUSTRATIVE EMBODIMENTS

The following detailed description discloses aspects of the disclosure and the ways it can be implemented. However, the description does not define or limit the invention, such definition or limitation being solely contained in the claims appended thereto. Although the best mode of carrying out the invention has been disclosed, those in the art would recognize that other embodiments for carrying out or practicing the invention are also possible.

The present disclosure pertains to a gesture-based recognition system and a method for interpreting the gestures of an occupant and obtaining the occupant's desired command inputs by interpreting the gestures.

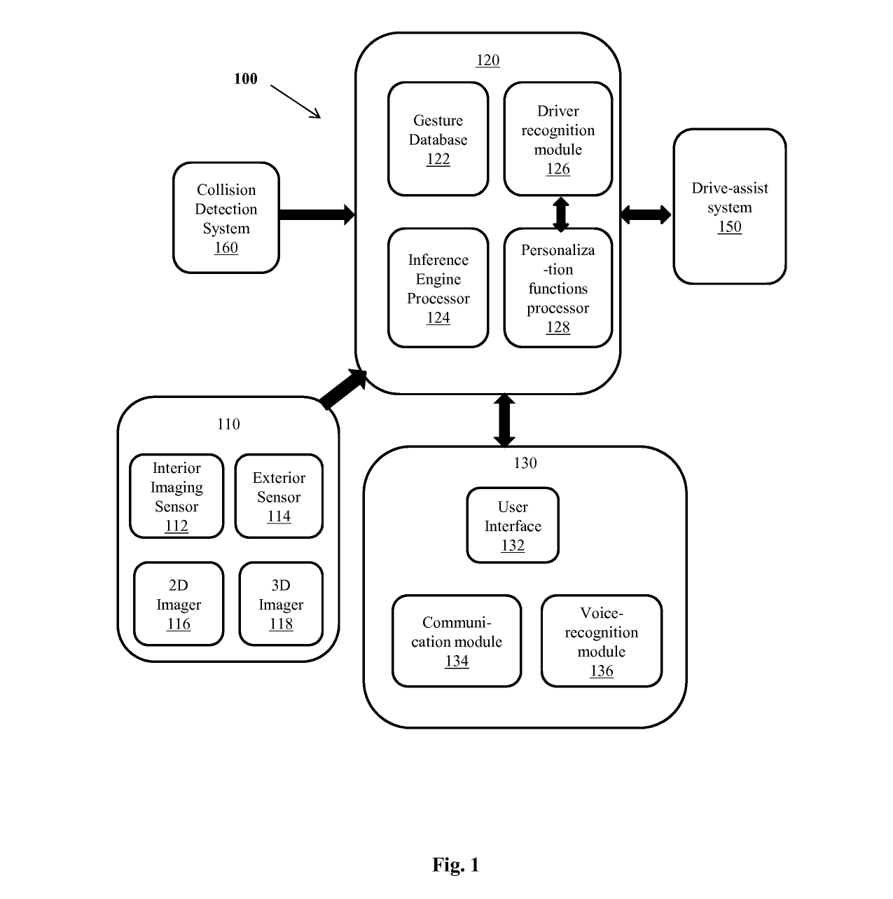

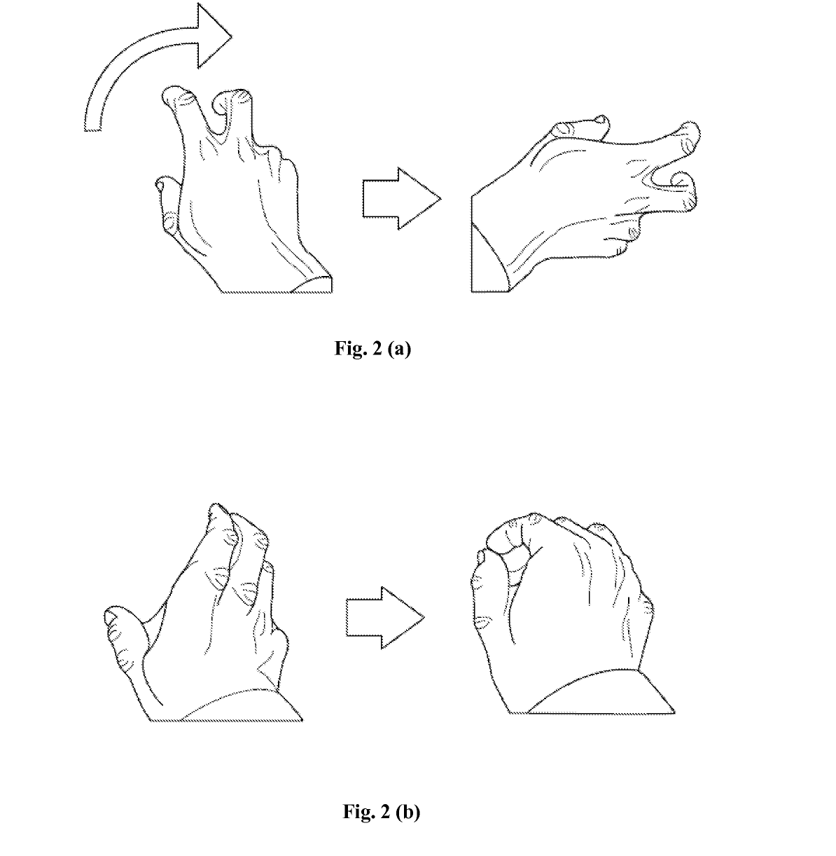

FIG. 1 shows an exemplary gesture-based recognition system 100, for interpreting the occupant's gestures and obtaining occupant's desired commands through recognition. The system 100 includes a means 110 for capturing an image of the interior section of a vehicle (not shown). Means 100 includes one or more interior imaging sensors 112 and a set of exterior sensors 114. The interior imaging sensors 112 observe the interior of the vehicle continuously. The one or more exterior sensors 114 observe the vehicle's external environment, and captures images thereof. Further, the exterior sensors 114 identify vehicles proximal to the occupant's vehicle, and provide warning signals corresponding to any potential collision threats to a drive-assist system 150. A two-dimensional imager 116, which may be a camera, captures 2D images of the interior of the vehicle. Further, means 110 includes a three-dimensional imager 118 for capturing a depth-map of the vehicle's interior section. The 3D imager 118 can include any appropriate device known in the art, compatible to automotive application and suitable for this purpose. A suitable 3D imager is a device made by PMD Technologies, which uses a custom-designed imager. Another suitable 3D imager can be a CMOS imager that works by measuring the distortion in the pattern of emitted light. Both of these devices actually rely on active illumination to form the required depth-map of the vehicle interiors. In another aspect, the 3D imager 118 can be a flash-imaging LIDAR that captures the entire interior view through a laser or a light pulse. The type of imager being used by means 100 would depend upon factors including cost constraints and package size, and the precision required to capture images of the vehicle's interior section.

The occupant's vehicle may also be equipped with a high-precision collision detection system 160, which may be any appropriate collision detection system commonly known in the art. The collision detection system 160 may include a set of radar sensors, image processors and side cameras etc., working in collaboration. The collision detection system 160 may also include a blind-spot monitoring system for side sensing and lane change assist (LCA), which is a short range sensing system for detecting a rapidly approaching adjacent vehicle. The primary mode of this system is a short-range sensing mode that normally operates at about 24 GHz. Blind spot detection systems can also include a vision-based system that uses cameras for blind-spot monitoring. In another embodiment, the collision detection system 160 may include a Valeo Raytheon system that operates at 24 GHz and monitors vehicles in the blind-spot areas on both sides of the vehicle. Using several beams of the multi-beam radar system, the Valeo system accurately determines the position, distance and relative speed of an approaching vehicle in the blind-spot region. The range of the system is around 40 meters, with about a 150 degree field of view.

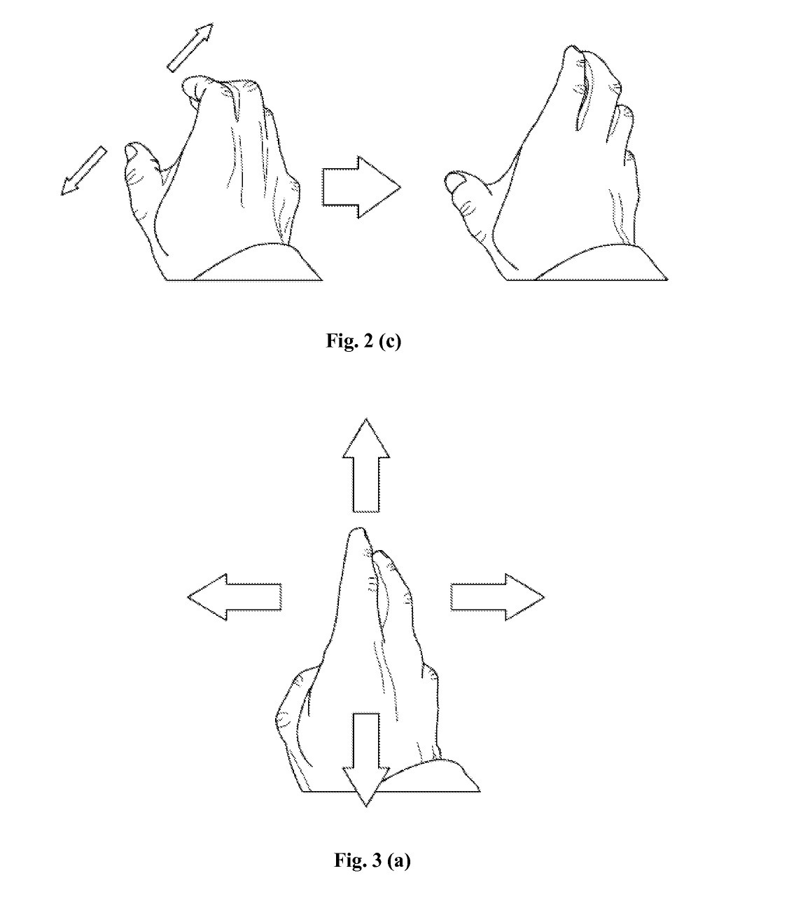

On identification of any potential collision threats, the collision detection system 160 provides corresponding signals to a gesture recognition processor 120. For simplicity and economy of expression, the gesture recognition processor 120 will be referred to as ‘processor 120’ hereinafter. As shown in FIG. 1, processor 120 is coupled to the collision detection system 160 and the means 110. After capturing the image of the interior section of the vehicle, the means 110 provides the captured image to the processor 120. The processor 120 analyzes the image and interprets the gestures of the occupant by first separating in the captured image, the occupant's image from the background. To identify and interpret gestures of the occupant, the processor 120 continuously interprets motions made by the user through his hands, arms, etc. The processor 120 includes a gesture database 122, containing a number of pre-determined images, corresponding to different gesture positions. The processor 120 compares the captured image with the set of pre-determined images stored in the gesture database 122, to interpret occupant's gesture. Typical images stored in the gesture database 122 are shown in FIG. 2 through FIG. 4. For instance, the image shown in FIG. 2(a) corresponds to a knob-adjustment command. This image shows the index finger, the middle finger and the thumb positioned in the air in a manner resembling the act of holding a knob. As observed through analysis of continuously captured images of the occupant, rotation of the hands, positioned in this manner, from left to right or vice versa, would let the processor 120 interpret that an adjustment to the volume of the music system, temperature control or fan speed control is desired by the occupant. With faster rotation in either direction, the processor 120 interprets a greater change in the function controlled, and slower rotation is interpreted as a need to have a finer control. The image shown in FIG. 2(b) corresponds to a zoom-out control. This representation includes positioning of the thumb, the index finger and the middle finger, initially with the thumb separated apart. The occupant has to start with the three fingers positioned in the air in this manner, and then bring the index and the middle finger close to the thumb, in a pinch motion. Slower motion allows a finer control over the zoom function, and a quick pinch is interpreted as a quick zoom out. The image in FIG. 2 (c) corresponds to a zoom-in function. This gesture is similar to the actual ‘unpinch to zoom’ feature on touch screens. The thumb is initially separated slightly away from the index and middle fingers, followed by movement of the thumb away from the index and middle fingers. When the processor 120 interprets gestures made by the occupant, similar to this image, it enables the zoom-out function on confirmation from the occupant, as explained below. The zoom out and zoom in gestures are used for enabling functions, including zoom control, on a display screen. This may include, though not be limited to, an in-vehicle map, which may be a map corresponding to a route planned by the vehicle's GPS/navigation system, zoom control for an in-vehicle web browser, or a control over any other in-vehicle function where a zoom out option is applicable, for example, album covers, a current playing list, etc.

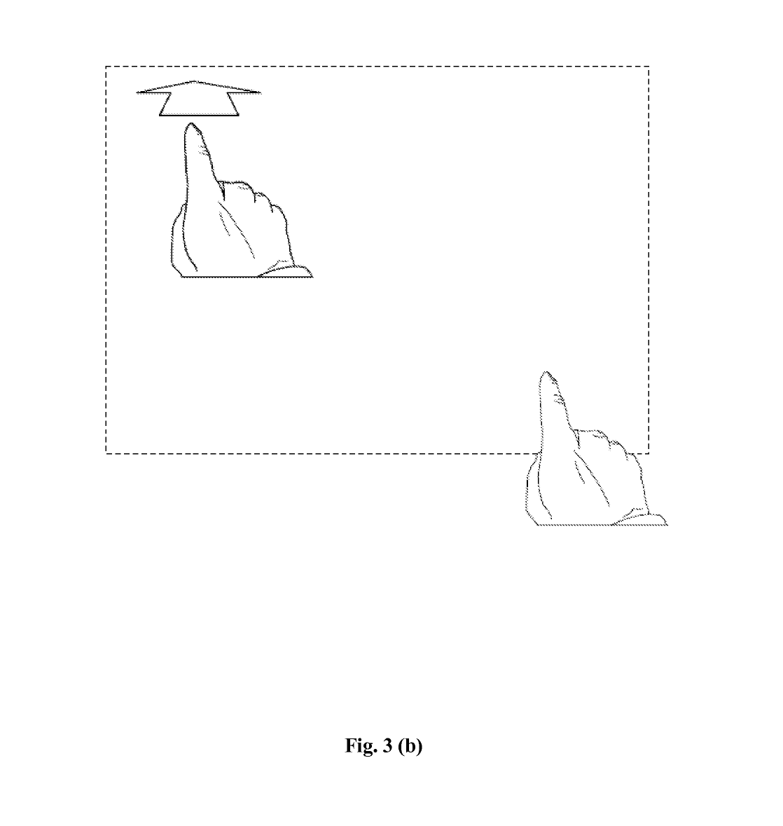

Another gesture that the processor 120 interprets, with the corresponding images being stored in database 122, is a Scrolling/Flipping/Panning feature, as shown in FIG. 3 (a). To enable this feature, the occupant has to point the index and middle fingers together, and sweep across towards left, right, upwards or downwards. Any of these motions, when interpreted by processor 120, results in scroll of the screen in the corresponding direction. Further, the speed of motion while making the gesture in the air correlates with the actual speed of scroll over a display screen. Specifically, a quicker sweeping of the fingers results in a quicker scroll through the display screen, and vice versa. The application of this gesture can include, though not be limited to, scrolling through a displayed map, flipping through a list of songs in an album, flipping through a radio system's frequencies, or scrolling through any menu displayed over the screen.

The image shown in FIG. 3 (b) corresponds to a selecting/pointing function. To enable this function, the occupant needs to position the index finger in the air, and push it slightly forward, imitating the actual pushing of a button, or selecting an option. For initiating a selection within a specific area on a display screen, the occupant needs to virtually point the index finger substantially in alignment with the area. For instance, if the occupant wishes to select a specific location on a displayed map, and zoom out to see areas around the location, he needs to point his fingers virtually in the air, in alignment with the location displayed. Pointing of the finger in a specific virtual area, as shown in FIG. 3 (b), leads to enabling selectable options in the corresponding direction projected forward towards the screen. This gesture can be used for various selections, including selecting a specific song in a list, selecting a specific icon in a displayed menu, exploring through a location of interest in a displayed map, etc.

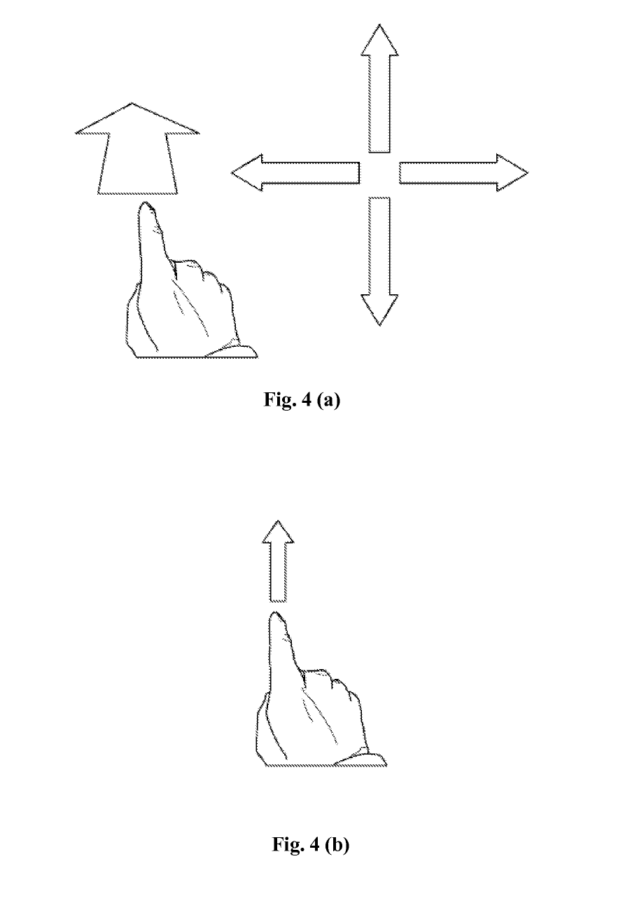

The image shown in FIG. 4 (a) is the gesture corresponding to a ‘click and drag’ option. To enable it, the occupant needs to virtually point his index finger in the air towards an option, resembling the actual pushing of a button/icon, and then move the finger along the desired direction. On interpretation of this gesture, it would result in dragging the item along that direction. This feature is useful in cases including a controlled scrolling through a displayed map, rearranging a displayed list of items by dragging specific items up or down, etc.

The gesture in FIG. 4 (b) corresponds to a ‘flick up’ function. The occupant needs to point his index finger and then move it upwards quickly. On interpretation of the gesture, enablement of this function results in moving back to a main menu from a sub-menu displayed on a touch screen. Alternatively, it can also be used to navigate within a main menu rendered on the screen.

Other similar explicable and eventually applicable gestures and their corresponding images in the database 122, though not shown in the disclosure drawings, include those corresponding to a moon roof opening/closing function. To enable this feature, the occupant needs to provide an input by posing a gesture pretending to grab a cord near the front of the moon-roof, and then pulling it backward, or pushing it forward. Continuous capturing of the occupant's image provides a better enabling of this gesture-based interpretation, and the opening/closing moon-roof stops at the point when the occupant's hand stops moving. Further, a quick yank backward or forward results in the complete opening/closing of the moon-roof. Another gesture results in pushing-up the moon-roof away from the occupant. The occupant needs to bring his hands near the moon-roof, with the palm facing upwards towards it, and then push the hand slightly further, upwards. To close a ventilated moon-roof, the occupant needs to bring his hands close to the moon-roof, pretend to hold a cord, and then pull it down. Another possible explicable gesture that can be interpreted by the gesture recognition processor 120, is the ‘swipe gesture’ (though not shown in the figures). This gesture is used to move a displayed content between the heads up display (HUD), the cluster and the center stack of the vehicle. To enable the functionality of this gesture, the occupant needs to point his index finger towards the content desired to be moved, and move the index finger in the desired direction, in a manner resembling the ‘swiping action’. Moving the index finger from the heads up display towards the center stack, for example, moves the pointed content from the HUD to the center stack.

Processor 120 includes an inference engine processor 124 (referred to as ‘processor 124’ hereinafter). Processor 124 uses the image captured by the means 110, and inputs from vehicle's interior sensors 112 and exterior sensors 114, to identify the driver's state of attentiveness. This includes identifying cases where the driver is found inattentive, such as being in a drowsy or a sleepy state, or conversing with a back seat/side occupant. In such cases, if there is a potential threat, as identified by the collision detection system 160, for instance, a vehicle rapidly approaching the occupant's vehicle and posing a collision threat, the detection system 160 passes potential threat signals to the processor 124. The processor 124 conveys driver's inattentiveness to a drive-assist system 150. The drive-assist system 150 provides a warning signal to the driver/occupant. Such warning signal is conveyed by either verbally communicating with the occupant, or by an alarming beep. Alternatively, the warning signal can be rendered on a user interface, with details thereof displayed on the interface. The exact time when such a warning signal is conveyed to the occupant would depend upon the occupant's attentiveness. Specifically, for a drowsy or a sleepy driver, the signals are conveyed immediately and much earlier than when the warning signal would be provided to an attentive driver. If the vehicle's exterior sensors 114 identify a sharp turn ahead, a sudden speed bump, or something similar, and the occupant is detected sitting without having fastened a seat-belt, then the driver assist system 150 can provide a signal to the occupant to fasten the seat belt.

The processor 120 further includes a driver recognition module 126, which is configured to identify the driver's image. Specifically, the driver recognition 126 module is configured to identify the image of the owner of the car, or the person who most frequently drives the car. In one embodiment, the driver recognition module 126 uses a facial recognition system that has a set of pre-stored images in a facial database, corresponding to the owner or the person who drives the car most frequently. Each time, when the owner drives the car again, the driver-recognition module obtains the captured image of the vehicle's interior section from the means 110, and matches the occupant's image with the images in the facial database. Those skilled in the art will recognize that the driver recognition module 126 extracts features or landmarks from the occupant's captured image, and matches those features with the images in the facial database. The driver recognition module can use any suitable recognition algorithm known in the art, for recognizing the driver, including the Fisherface algorithm that uses Elastic bunch graph matching, Linear discriminate analysis, Dynamic link matching, and so on.

Once the driver recognition module 126 recognizes the driver/owner occupying the driving seat, it passes signals to a personalization functions processor 128. The personalization functions processor 128 readjusts a set of vehicle's personalization functions to a set of pre-stored settings. The pre-stored settings correspond to the driver's preferences, for example, a preferred temperature value for the air-conditioning system, a preferred range for the volume of the music controls, the most frequently visited radio frequency band, readjusting the driver's seat to the preferred comfortable position, etc.

A command actuator 130 (referred to as ‘actuator 130’ hereinafter) is coupled to the processor 120. The actuator 130 actuates the occupant's desired command after the processor 120 interprets the occupant's gesture. Specifically, on interpreting the occupant's gesture, the processor 120 generates a corresponding output and delivers the output to the actuator 130. The actuator 130 generates the desired command using the output, and sends a confirmation message to the occupant, before actuating the command. The confirmation message can be verbally communicated to the occupant through a communication module 134, in a questioning mode, or it can be rendered over a user interface 132 with an approving option embedded therein (i.e., ‘Yes’ or ‘No’ icons). The occupant confirms the interpreted command either by providing a verbal confirmation, or clicking the approving option on the user interface 132. In cases where the occupant provides a verbal confirmation, a voice-recognition module 136 interprets the confirmation. Eventually, the actuator 130 executes the occupant's desired command. In a case where a gesture is misinterpreted, and a denial to execute the interpreted command is obtained from the occupant, the actuator 130 renders a confirmation message corresponding to a different command option, though similar to the previous one. For instance, if the desired command is to increase the volume of music system, and it is misinterpreted as increasing the temperature of the air-conditioning system, then on receipt of a denial from the occupant in the first turn, the actuator 130 renders confirmation messages corresponding to other commands, until the desired action is implementable. In one embodiment, the occupant provides a gesture-based confirmation on the rendered confirmation message. For example, a gesture corresponding to the occupant's approval to execute an interpreted command can be a ‘thumb-up’ in the air, and a denial can be interpreted by a ‘thumb-down’ gesture. In those aspects, the gesture database 122 stores the corresponding images for the processor 120 to interpret the gesture-based approvals.

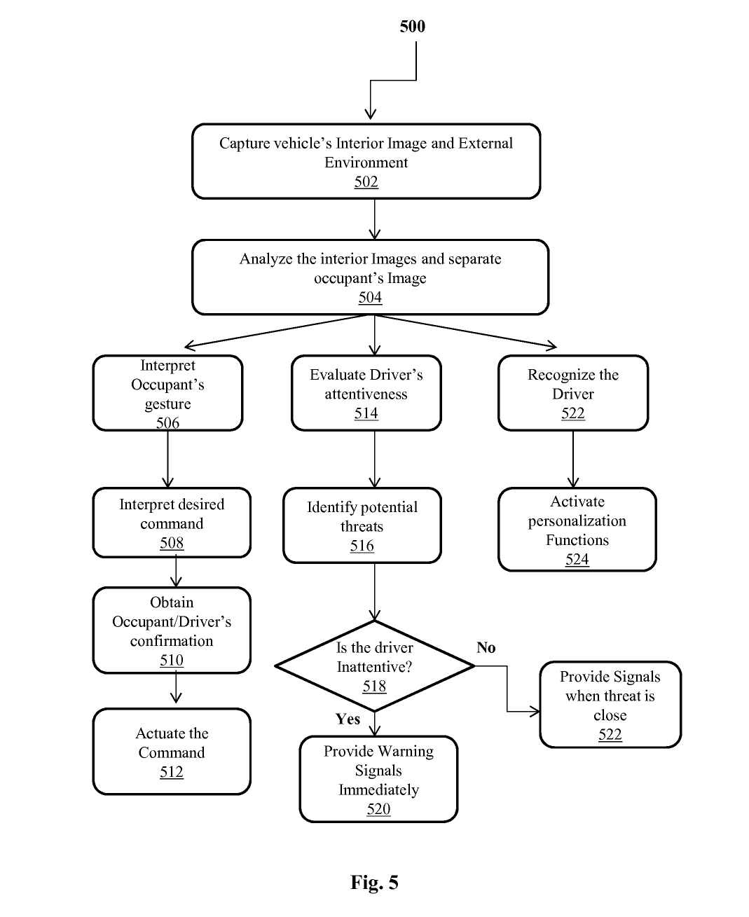

The FIG. 5 flowchart discloses different steps in a method 500 for interpreting a vehicle occupant's gestures, and obtaining the occupant's desired command inputs. At step 502, an image of the vehicle's interior section and the external environment is captured. The image for the interior section of the vehicle can be a two-dimensional image obtainable through a camera, or a three-dimensional image depth map of the vehicle's interiors, obtainable through suitable devices known in the art, as explained before. At step 504, the method analyzes the captured image of the interior section, and separates the occupant's image from it. At step 506, the separated image is analyzed and the occupant's gesture is interpreted from it. In one embodiment, the interpretation of the occupant's gesture includes matching the captured image with a set of pre-stored images corresponding to different gestures. Different algorithms available in art can be used for this purpose, as discussed above. The approach used by such algorithms can be either a geometric approach that concentrates on the distinguishing features of the captured image, or a photometric approach that distills the image into values, and then compares those values with features of pre-stored images. On interpretation of the occupant's gesture, at step 508, an interpretation of a corresponding desired occupant command is made. At step 510, the method obtains a confirmation message from the occupant regarding whether the interpreted command is the occupant's desired command. This is done to incorporate cases where the occupant's gesture is misinterpreted. At step 512, if the occupant confirms, then the interpreted command is actuated. When the occupant does not confirm the interpreted command, and wishes to execute another command, then the method delivers another confirmation message to the occupant corresponding to another possible command pertaining to the interpreted gesture. For example, in case the method interprets the occupant's gesture of rotating his hands to rotate a knob, and delivers a first confirmation message asking whether to increase/decrease the music system's volume, and the occupant denies the confirmation, then a second relevant confirmation message can be rendered, which may be increasing/decreasing the fan speed, for example.

At step 514, the method evaluates the driver's state of attentiveness by analyzing the captured image for the vehicle's interior section. At step 516, the method identifies any potential threats, for example, any rapidly approaching vehicle, an upcoming speed bump, or a steep turn ahead. Any suitable means known in the art can be used for this purpose, including in-vehicle collision detection systems, radars, lidar, vehicle's interior and external sensors. If a potential threat exists, and the driver is found inattentive, then at step 520, warning signals are provided to the occupant at a specific time. The exact time when such signals are provided depends on the level of attentiveness of the occupant/driver, and for the case of a sleepy/drowsy driver, such signals are provided immediately.

At step 522, the method 500 recognizes the driver through an analysis of the captured image. Suitable methods, including facial recognition systems known in the art, as explained earlier, can be used for the recognition. The image of the owner of the car, or the person who drives the car very often, can be stored in a facial database. When the same person enters the car again, the method 500 matches the captured image of the person with the images in the facial database, to recognize him. On recognition, at step 524, a set of personalization functions corresponding to the person are reset to a set of pre-stored settings. For example, the temperature of the interiors can be automatically set to a pre-specified value or the driver-side window may half-open automatically when the person occupies the seat, as preferred by him normally.

The disclosed gesture-based recognition system can be used in any vehicle, equipped with suitable devices as described before, for achieving the objects of the disclosure.

Although the current invention has been described comprehensively, in considerable details to cover the possible aspects and embodiments, those skilled in the art would recognize that other versions of the invention may also be possible.

What is claimed is:

1. A gesture-based recognition system for interpreting a vehicle occupant's gesture and obtaining the occupant's desired command inputs through gesture recognition, the system comprising:
a means for capturing an image of the vehicle's interior section;
a gesture recognition processor adapted to separate the occupant's image from the captured image, and further adapted to interpret occupant's gestures from the image and generate an output; and
a command actuator coupled to the gesture recognition processor and adapted to receive the output therefrom, interpret a desired command, and actuate the command based on a confirmation received from the occupant.

2. A system of claim 1, wherein the means includes a camera configured to obtain a two dimensional image or a three dimensional depth-map of the vehicle's interior section.

3. A system of claim 1, wherein the command actuator includes a user interface configured to display the desired command and a corresponding confirmation message, prompting the occupant to provide the confirmation.

4. A system of claim 1, wherein the command actuator includes a communication module configured to verbally communicate the interpreted occupant's gesture to the occupant, and a voice-recognition module configured to recognize a corresponding verbal confirmation from the occupant.

5. A system of claim 1, wherein the gesture recognition processor includes a database storing a set of pre-determined gesture images corresponding to different gesture-based commands.

6. A system of claim 5, wherein the pre-determined images include at least the images corresponding to knob-adjustment, zoom-in and zoom-out controls, click to select, scroll-through, flip-through, and click to drag.

7. A system of claim 1, wherein the gesture-recognition processor further comprises an inference engine processor configured to assess the occupant's attentiveness; the system further comprising a drive-assist system coupled to the inference engine processor to receive inputs therefrom, if the occupant is inattentive.

8. A system of claim 6, further comprising a collision detection system coupled to the drive-assist system and the inference engine processor, the collision detection system being adapted to assess any potential threats and provide corresponding threat signals to the drive assist system.

9. A system of claim 1, wherein the gesture recognition processor includes a driver recognition module configured to recognize the driver's image and re-adjust a set of personalization functions to a set of pre-stored settings corresponding to the driver, based on the recognition.

10. A system of claim 9, wherein the driver recognition module includes a facial database containing a set of pre-stored images, and is configured to compare features from the captured image with the images in the facial database.

11. A method of interpreting a vehicle occupant's gesture and obtaining occupant's desired command inputs through gesture-recognition, the method comprising:
capturing an image of the vehicle's interior section;
separating the occupant's image from the captured image, analyzing the separated image, and interpreting the occupant's gesture from the separated image;
interpreting the occupant's desired command, generating a corresponding confirmation message and delivering the message to the occupant; and
obtaining the confirmation from the occupant and actuating the command.

12. A method of claim 11, wherein capturing the image includes obtaining a two-dimensional image or a three-dimensional depth map of the vehicle's interior.

13. A method of claim 11, further comprising rendering the interpreted desired command along with a corresponding confirmation message through a user interface.

14. A method of claim 11, further comprising verbally communicating the interpreted desired command and receiving a verbal confirmation from the occupant through voice-based recognition.

15. A method of claim 11, further comprising obtaining the confirmation from the occupant through gesture recognition.

16. A method of claim 11, further comprising comparing the captured image or the separated image with a set of pre-stored images corresponding to a set of pre-defined gestures, to interpret the occupant's gesture.

17. A method of claim 11, further comprising assessing the occupant's state of attentiveness and any potential threats, and providing warning signals to the occupant based on occupant's state of attentiveness.

18. A method of claim 11, further comprising detecting a potential collision threat and providing warning signals to the occupant based on the detection.

19. A method of claim 11, further comprising recognizing the driver's image in the separated image, and re-adjusting a set of personalization functions to a set of pre-stored settings.

20. A method of claim 19, wherein recognizing the driver's image comprises comparing features of the captured image with the features of a set of pre-stored images in a facial database.
